(19) United States
(12) Patent Application Publication
(10) Pub. No.: US 2021/0018663 A1
(43) Pub. Date: Jan. 21, 2021

(54) TUNABLE FILTER AND OPTICAL COMMUNICATION APPARATUS

(71) Applicant: Santec Corporation, Aichi (JP)

(72) Inventor: Yasuki Sakurai, Aichi (JP)

(73) Assignee: Santec Corporation, Aichi (JP)

(21) Appl. No.: 17/062,081

(22) Filed: Oct. 2, 2020

Related U.S. Application Data
(62) Division of application No. 16/420,336, filed on May 23, 2019.

(30) Foreign Application Priority Data
Jul. 30, 2018 (JP) 2018-142407

(51) Int. Cl. G02B 5/28; G02B 6/293; G01J 3/26; G02B 6/12; G02B 6/42

(52) U.S. Cl. CPC G02B 5/28; G02B 6/29395; G02B 6/4215; G01J 3/26; G02B 6/12; G02B 6/29398

(57) ABSTRACT

A tunable filter includes: a first transparent substrate including a first reflective surface; a second transparent substrate including a second reflective surface that opposes the first reflective surface; and a supporting member, connected to the first transparent substrate, that supports the second transparent substrate on the first transparent substrate so that the second reflective surface is disposed at a position separated from the first reflective surface in a normal direction of the first reflective surface. A cavity between the first reflective surface and the second reflective surface forms an etalon. A relative position of the second transparent substrate with respect to the first transparent substrate changes due to thermal expansion of the supporting member, and a length of the cavity changes in the normal direction.

### TECHNICAL FIELD

The present invention relates to a tunable filter and an optical communication apparatus.

### BACKGROUND

Conventionally, optical communication apparatuses such as optical transceivers or optical transponders are known. Such optical communication apparatuses have internally mounted optical devices such as optical power attenuators, optical power monitors, and tunable filters. The size of an optical communication apparatus is limited by standards such as CFP, CFP2, and CFP4, and miniaturization is therefore desired.

A tunable filter using a diffraction grating is known as a tunable filter (for example, see patent document 1). A tunable filter using an etalon is also known.

### PRIOR ART LITERATURE

### Patent Literature

[Patent Literature 1] US Patent Publication No. 2008/0085119

Tunable filters using diffraction grating are configured so that light of a specific wavelength is reflected by a MEMS mirror after light is spatially separated into each wavelength by the diffraction grating. Therefore, tunable filters using diffraction grating require a wide space, and there is a limit to miniaturization.

While tunable filters using etalon are more suitable for miniaturization compared to tunable filters using diffraction grating, they have the following disadvantages. Filters that utilize an electrooptic effect of liquid crystal, filters that utilize a thermooptic effect of a cavity material, and air gap filters that change transmitted wavelengths by dynamically changing a cavity length are known as tunable filters using etalon.

In filters that utilize an electrooptic effect of liquid crystal, the electrooptic effect of liquid crystal has a strong polarization dependence, so it is necessary to suppress the effects of polarization dependence using an optical component such as a polarization splitter and a wavelength plate, and the filter configuration has the disadvantages of being complex and expensive.

In filters that utilize a thermooptic effect of a cavity material, an inorganic material can be used as the cavity material, so although there is the advantage of being able to produce etalon using only a film forming process, the thermooptic coefficient of the inorganic material is not very large, so there is the disadvantage of a high temperature application being necessary to change the transmitted wavelength.

For example, an inorganic material a-Si that can be used in a film forming process has a thermooptic coefficient of approximately 18×10⁻³/° C., but even if such an inorganic material having a high thermooptic coefficient is used, it is necessary to make a temperature adjustment of 220 degrees (° C.) to change the transmitted wavelength 40 nm at a C band having a wavelength of 1530 nm to 1565 nm. In such filters that require a high temperature application, integration and packaging with other components is difficult.

Additionally, in air gap filters, the cavity length is adjusted using MEMS or a piezoelectric element, so there are the disadvantages of the filter structure being complex, and having high production costs for the filter.

### SUMMARY

According to one or more embodiments of the present invention, it is desirable to be able to provide a tunable filter that has a simple structure, and that can drastically change the transmitted wavelength with a small temperature change as a tunable filter using an etalon.

The tunable filter according to one or more embodiments of the present invention is provided with a first transparent substrate, a second transparent substrate, and a supporting member. The first transparent substrate has a first reflective surface. The second transparent substrate has a second reflective surface opposing the first reflective surface. The second transparent substrate configures an etalon along with the first transparent substrate.

The supporting member is connected to the first transparent substrate. The supporting member supports the second transparent substrate on the first transparent substrate so that the second reflective surface is disposed on a position separated from the first reflective surface in a normal direction of the first reflective surface, and so that a cavity is formed between the first reflective surface and the second reflective surface.

This tunable filter is configured so that a relative position of the second transparent substrate with respect to the first transparent substrate changes due to thermal expansion of the supporting member, and a length of the cavity changes in the normal direction.

According to one or more embodiments of the present invention, the supporting member is provided extending from a connecting portion with the first transparent substrate toward the second transparent substrate, to a position separated farther from the first transparent substrate than the second reflective surface that defines a boundary of the cavity. The second transparent substrate is connected to the supporting member at a position separated from the first transparent substrate via the second reflective surface.

In this manner, according to a tunable filter in which first and second transparent substrates and a supporting member are connected, the distance between connecting points of the first and second transparent substrates and the supporting member is longer than the distance between a first reflective surface and second reflective surface that define the cavity length. The amount of change in the cavity length due to thermal expansion of the supporting member corresponds to multiplying the thermal expansion coefficient of the supporting member, the length of the supporting member between connecting points, and the amount of change in temperature.

Therefore, in this tunable filter, the amount of change in the cavity length per change in temperature is larger than when the supporting member is disposed between the first reflective surface and the second reflective surface and the supporting member is connected to the first and second reflective surfaces. Therefore, according to one or more embodiments of the present invention, it is possible to provide a tunable filter that has a simple structure, and that can drastically change the transmitted wavelength with a small temperature change as a tunable filter using etalon.

According to one or more embodiments of the present invention, the supporting member may have a side wall and an upper wall. The side wall may be configured to extend from a connecting portion with the first transparent substrate toward the second transparent substrate, to a position corresponding to a back surface of the second transparent substrate positioned on a side opposite the second reflective surface. The upper wall may be configured to extend from the side wall along the back surface of the second transparent substrate. In this case, the second transparent substrate may be connected to the upper wall of the supporting member on the back surface. According to this connecting system, it is possible to make the length of the supporting member between connecting points larger, and it is possible to provide a tunable filter that can drastically change the transmitted wavelength with a small temperature change.

According to one or more embodiments of the present invention, the supporting member may be provided with a first plate and a second plate. The side wall may be configured by the first plate, and the upper wall may be configured by the second plate. The first plate may be disposed on the first transparent substrate to surround the second transparent substrate. The second plate may be disposed on the first plate.

Finesse, which is a transmission property of etalon, depends on the degree of parallelization of the first transparent substrate and the second transparent substrate. When configuring the side wall and the upper wall using the first and second plate, the upper wall can be disposed with higher precision, and a more favorable degree of parallelization can be realized than when configuring the side wall and the upper wall using machining. Therefore, a favorable finesse can be realized.

According to one or more embodiments of the present invention, the first plate may be connected to the second plate using an adhesive having a filler that reduces thermal expansion mixed therein. According to one or more embodiments of the present invention, the supporting member may be connected to the first transparent substrate and the second transparent substrate using an adhesive having a filler that reduces thermal expansion mixed therein. According to one example, the filler is quartz. If an adhesive having low thermal contraction is used, effects on the degree of parallelization due to thermal contraction of the adhesive can be suppressed.

According to one or more embodiments of the present invention, the tunable filter may be mounted on an optical communication apparatus. According to one or more embodiments of the present invention, an optical communication apparatus that is provided with the tunable filter described above can be provided. If an optical communication apparatus is configured using the tunable filter according to one or more embodiments of the present invention, the optical communication apparatus can be miniaturized.

### BRIEF DESCRIPTION OF DRAWINGS

FIG. 1 is a block diagram illustrating the configuration of an optical communication apparatus according to one or more embodiments.

FIG. 2A is a cross-sectional diagram of a tunable filter according to one or more embodiments, and FIG. 2B is a plan diagram of a tunable filter according to one or more embodiments.

FIG. 3 is a cross-sectional diagram of a tunable filter according to one or more embodiments.

FIG. 4 is a development diagram of a tunable filter according to one or more embodiments.

FIG. 5 is a cross-sectional diagram of a tunable filter according to one or more embodiments.

FIG. 6 is a cross-sectional diagram of a tunable filter according to one or more embodiments.

### DETAILED DESCRIPTION

Exemplary embodiments of the present invention will be described below with reference to drawings.

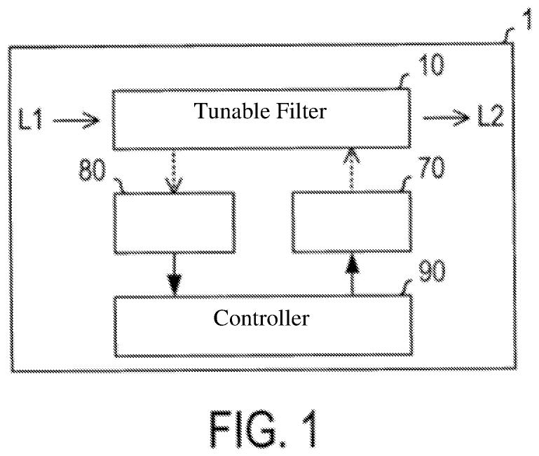

An optical communication apparatus 1 of one or more embodiments illustrated in FIG. 1 is provided with a tunable filter 10 connected to an optical transmission line, a temperature regulator 70, a temperature sensor 80, and a controller 90.

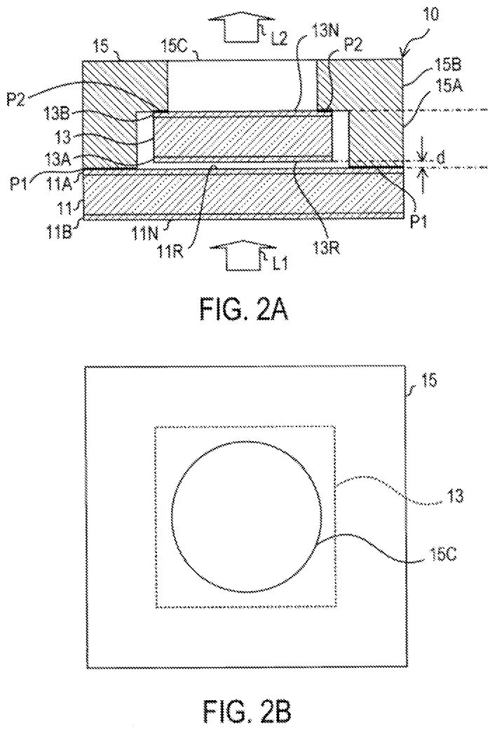

From among optical signals L1 input from upstream in the optical transmission line, the tunable filter 10 is configured to selectively transmit optical signals L2 of a specific wavelength, and output to downstream in the optical transmission line. Specifically, this tunable filter 10 is configured as an air gap etalon filter, and is configured to selectively transmit wavelength components corresponding to a cavity length d (see FIG. 2). The cavity length d changes depending on the temperature of the tunable filter 10, and the temperature of the tunable filter 10 is adjusted and maintained to a target temperature corresponding to the optical wavelength to be transmitted by the temperature regulator 70.

The temperature regulator 70 is configured by, for example, a Peltier element. The temperature regulator 70 is controlled by the controller 90, and adjusts and maintains the temperature of the tunable filter 10 to the target temperature. This adjusting and maintaining is realized by the controller 90 controlling the temperature regulator 70 based on input signals from the temperature sensor 80.

The temperature sensor 80 is configured by, for example, a thermistor, and is disposed so that the temperature of the tunable filter 10 can be sensed. According to one example, the temperature regulator 70 and the temperature sensor 80 are integrally configured to the tunable filter 10.

The controller 90 controls the temperature regulator 70 so that the temperature of the tunable filter 10 is maintained at a target temperature corresponding to an optical wavelength to be transmitted based on input signals from the temperature sensor 80.

The detailed configuration of the tunable filter 10 according to one or more embodiments will be described using FIG. 2A and FIG. 2B. As illustrated in FIG. 2A, the tunable filter 10 is provided with a first transparent substrate 11, a second transparent substrate 13, and a supporting member 15. The first transparent substrate 11 and second transparent substrate 13 are disposed in parallel having a gap therebetween, configuring a parallel plate.

The first transparent substrate 11 has a highly reflective coating 11A on a reflective surface 11R that opposes the second transparent substrate 13, and has a non-reflective coating 11B on an input surface 11N to which optical signals L1 are input, on the side opposite the reflective surface 11R. The reflective surface 11R of the first transparent substrate 11 is also expressed below as a first reflective surface 11R. For example, the first transparent substrate 11 is created by forming the highly reflective coating 11A on a front surface of a rectangular plate-shaped transparent substrate main body having the front surface and a back surface parallel to each other, and forming the non-reflective coating 11B on the back surface.

The second transparent substrate 13 also has the same structure as the first transparent substrate 11. In other words, the second transparent substrate 13 has a highly reflective coating 13A on a reflective surface 13R opposite the first transparent substrate 11, and a non-reflective coating 13B on an output surface 13N outputting an optical signal L2 on the opposite side of the reflective surface 13R. The reflective surface 13R of the second transparent substrate 13 is also expressed below as a second reflective surface 13R. For example, the second transparent substrate 13 is created by forming the highly reflective coating 13A on a front surface of a rectangular plate-shaped transparent substrate main body having the front surface and a back surface parallel to each other, and forming the non-reflective coating 13B on the back surface.

The first transparent substrate 11 and second transparent substrate 13 are created using, for example, a transparent substrate main body of the same material. The transparent substrate main body used for creation is, for example, a quartz glass substrate with both sides in parallel.

The supporting member 15 supports the second transparent substrate 13 on the first transparent substrate 11 so that the second reflective surface 13R is disposed on a position separated from the first reflective surface 11R in the normal direction of the first reflective surface 11R, and so that a cavity is formed between the first reflective surface 11R and the second reflective surface 13R.

Specifically, the supporting member 15 is configured so that a wall having an upside down L shape on the cross-section along the normal direction of the first reflective surface 11R is provided along the outer edge of the first reflective surface 11R. As illustrated in FIG. 2A, the supporting member 15 has a side wall 15A extending in the normal direction of the first reflective surface 11R from the first reflective surface 11R and an upper wall 15B extending in parallel with the first reflective surface 11R from the upper end of the side wall 15A. The lower end of the side wall 15A is adhered to the first reflective surface 11R using an adhesive. The supporting member 15 is connected to the first transparent substrate 11 using this adhesive.

The side wall 15A is provided along the four sides of the rectangular first reflective surface 11R, and defines a rectangular parallelepiped housing space. The second transparent substrate 13 is disposed in the housing space surrounded by the side wall 15A.

The upper wall 15B is provided with a circular opening portion 15C having a diameter smaller than one side of the rectangular second transparent substrate 13. The broken line in FIG. 2B is illustrated transmitting through the outer edge of the second transparent substrate 13. The optical signals L2 output from the output surface 13N of the second transparent substrate 13 are transmitted downstream in the optical transmission line through this opening portion 15C.

The output surface 13N of the second transparent substrate 13 is adhered to a lower surface of the upper wall 15B via an adhesive around this opening portion 15c, the upper wall 15B being joined to the housing space. The second transparent substrate 13 is connected to and supported by the supporting member 15 by this adhesive so that the second reflective surface 13R is disposed in parallel with the first reflective surface 11R, being separated from the first reflective surface 11R a distance corresponding to the cavity length d in the normal direction of the first reflective surface 11R.

In one or more embodiments, the thermal expansion of the supporting member 15 is utilized to change the cavity length d between the first reflective surface 11R and the second reflective surface 13R, thereby changing the transmitted wavelength of the tunable filter 10. Therefore, a material having a high thermal expansion coefficient is used as the supporting member 15. For example, the supporting member 15 is configured by an aluminum material having a linear expansion coefficient of approximately 2.3×10⁻⁵/° C.

Meanwhile, an adhesive having a filler mixed therein is used for connecting on a connecting portion P1 of the first transparent substrate 11 and the supporting member 15, and a connecting portion P2 of the second transparent substrate 13 and the supporting member 15. The filler is selected from materials suitable for reducing thermal contraction of the adhesive. For example, the filler is configured by quartz. By utilizing an adhesive having low thermal contraction in this manner, effects on the degree of parallelization of the second transparent substrate 13 due to thermal contraction are suppressed.

The tunable filter 10 of one or more embodiments is characteristic in that a length L of the supporting member 15 between the connecting portions P1 and P2 is significantly longer than the cavity length d. Conventionally known etalon filters are configured by a spacer being inserted as a supporting member between two transparent substrates that configure a parallel plate. Therefore, the length of the supporting member between the connecting portions of the supporting member and the two transparent substrates matches the cavity length d in conventional etalon filters.

An amount of change Δd of the cavity length d can be represented in the following formula based on a linear expansion coefficient α of the supporting member 15, an amount of change ΔT in temperature, and a length L between the connecting portions P1 and P2.

Δd=α*L*ΔT

Therefore, the cavity length d is drastically changed at a small amount of change ΔT in temperature, and it can be understood that it is better for the length L to be large to thereby drastically change the transmitted wavelength. In light of this, it can be understood that the tunable filter 10 of one or more embodiments excels in variability in transmitted wavelengths more than the conventional etalon filter wherein the length L matches the cavity length d.

One indicator of transmission properties of an etalon filter is FSR (Free Spectral Range). FSR becomes smaller the larger the cavity length d is. FSR is determined based on the bandwidth of the input optical signals. When considering that the tunable filter 10 is applied to C band optical communications, an FSR of approximately 120 nm is required. The cavity length d required to realize an FSR of 120 nm is approximately 10 μm. Here, a change in cavity length d of approximately 0.3 μm is necessary to realize a wavelength variability of 40 nm corresponding to the entire C band at amount of change ΔT in temperature=40° C.

To realize this 40 nm wavelength variability in a conventional etalon filter, a supporting member (spacer) linear expansion coefficient of about 1×10⁻³/° C. is required, but a metal and inorganic material that has such a linear expansion coefficient does not exist.

In contrast, according to the tunable filter 10 of one or more embodiments, as described above, a wavelength variability of 40 nm can also be realized by configuring the supporting member 15 by an aluminum material having a linear expansion coefficient of approximately 2.3×10⁻⁵/° C. Specifically, if the length L of the supporting member 15 between the connecting portions P1 and P2 is approximately 750 μm, Δd=0.3 μm can be realized at amount of change ΔT in temperature=40° C., and a wavelength variability of 40 nm can be realized.

The thickness of the second transparent substrate 13 is sufficiently large with respect to the cavity length d. Therefore, according to one or more embodiments, it is possible to set the length L described above, and a tunable filter 10 suitable for C band optical communication can be configured having a wavelength variable range of 40 nm at amount of change ΔT in temperature=40° C.

Another indicator of transmission properties of an etalon filter in addition to FSR is finesse. Finesse is the degree of parallelization of the parallel plate, that is, it deteriorates as the degree of parallelization between the first transparent substrate 11 and the second transparent substrate 13 gets lower. Therefore, when high finesse is demanded, it is necessary to accordingly form the supporting member 15 with high precision. However, there are limits to machining materials and forming the side wall 15A and the upper wall 15B with high precision. Therefore, the supporting member 15 may be formed by stacking plates together as in one or more embodiments described below.

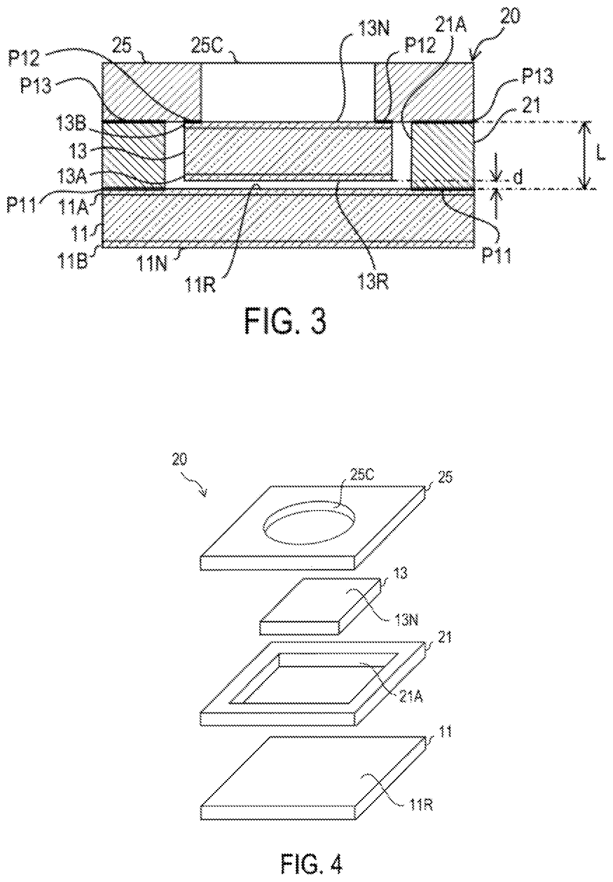

The optical communication apparatus 1 of one or more embodiments has a tunable filter 20 illustrated in FIG. 3 mounted instead of the tunable filter 10 of the embodiments described above. The optical communication apparatus 1 of one or more embodiments is the same as the embodiments described above except that the tunable filter 20 is different from the embodiments described above.

Moreover, the tunable filter 20 of one or more embodiments is different from the tunable filter 10 of the embodiments described above because the supporting member 15 in the tunable filter 10 of the embodiments described above is replaced with two plates, but other than this, it is configured the same as the embodiments described above. Therefore, a peculiar configuration of the tunable filter 20 will be selectively described below. Configuration parts in the tunable filter 20 that are the same in the embodiments described above will be given the same reference numerals as the embodiments described above, and a detailed description of such parts will be omitted.

The tunable filter 20 of one or more embodiments is provided with two plates in addition to the first transparent substrate 11 and the second transparent substrate 13; specifically, a side wall plate 21 and an upper wall plate 25. In the tunable filter 20, as illustrated in FIG. 4, a supporting structure similar to the supporting member 15 in the embodiments described above is realized by the side wall plate 21 and the upper wall plate 25 being stacked together on the first reflective surface 11R.

The side wall plate 21 and the upper wall plate 25 are respectively and individually created by chemically processing a base material via wet etching. After this, the side wall plate 21 and the upper wall plate 25 are connected together by being stacked together interposing an adhesive therebetween.

The side wall plate 21 is configured having an opening portion 21A forming the housing space of the second transparent substrate 13 on the inner side of plates having both sides parallel. In other words, the side wall plate 21 is configured having an outer shape of a rectangular frame having an opening portion 21A, and the outer shape of the rectangular frame forms a structure corresponding to the side wall 15A of the supporting member 15. The lower surface of the side wall plate 21 is connected to the first reflective surface 11R via an adhesive. The upper surface of the side wall plate 21 is connected to the lower surface of the upper wall plate 25 via an adhesive.

The upper wall plate 25 is configured as an opening plate provided with a circular opening portion 25C having a diameter smaller than the side of the second transparent substrate 13, similar to the upper wall 15B of the supporting member 15. The optical signals L2 output from the output surface 13N of the second transparent substrate 13 are transmitted downstream in the optical transmission line through this opening portion 25C.

The output surface 13N of the second transparent substrate 13 is adhered to a lower surface of the upper wall plate 25 via an adhesive around this opening portion 25c, the upper wall plate 25 being joined to the housing space. The second transparent substrate 13 is connected to and supported by the upper wall plate 25 by this adhesive so that the second reflective surface 13R is disposed in parallel with the first reflective surface 11R, being separated from the first reflective surface 11R a distance corresponding to the cavity length d in the normal direction of the first reflective surface 11R.

Similar to the embodiments described above, an adhesive having a filler (for example, quartz) for reducing thermal contraction mixed therein is used for connecting on a connecting portion P11 of the first transparent substrate 11 and the side wall plate 21, a connecting portion P12 of the second transparent substrate 13 and the upper wall plate 25, and a connecting portion P13 of the side wall plate 21 and the upper wall plate 25.

According to one or more embodiments, a structure corresponding to the supporting member 15 is realized by combining the side wall plate 21 to the upper wall plate 25. The side wall plate 21 and the upper wall plate 25 are formed using chemical processing to a shape having both sides parallel with high precision.

Therefore, the lower surface of the upper wall plate 25 can be precisely disposed parallel to the first reflective surface 11R, the second transparent substrate 13 can be precisely disposed parallel to the first transparent substrate 11, and a high degree of parallelization can be realized between the first reflective surface 11R and the second reflective surface 13R.

As a result, according to one or more embodiments, high finesse can be realized without requiring high-precision machining, and a high performance tunable filter 20 can be provided. By configuring the side wall plate 21 and the upper wall plate 25 using a material having a high linear expansion coefficient such as an aluminum material, a tunable filter 20 can be configured having the same wavelength variable range as the range in the embodiments described above.

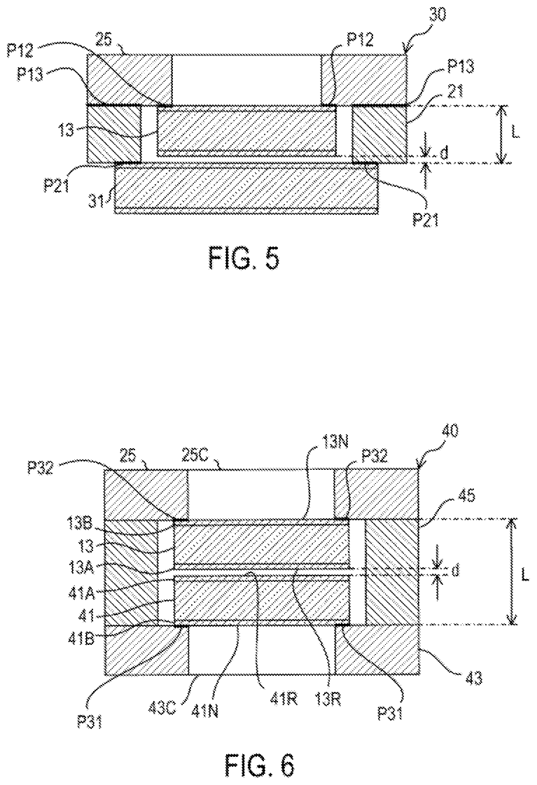

The optical communication apparatus 1 of one or more embodiments is provided with a tunable filter 30 illustrated in FIG. 5 instead of the tunable filter 10 of embodiments described above. It should be understood that parts in the tunable filter 30 illustrated in FIG. 5 that have the same reference numerals as embodiments described above have the same configuration as the corresponding parts in embodiments described above. The optical communication apparatus 1 of one or more embodiments is configured the same as the optical communication apparatus 1 of embodiments described above except that the tunable filter 30 is partially different from embodiments described above.

As can be understood from FIG. 5, the tunable filter 30 is provided with a first transparent substrate 31 having a smaller size when compared to the first transparent substrate 11 of the embodiments described above. The first transparent substrate 31 is small compared to the side wall plate 21, and only one portion of the lower surface of the side wall plate 21 is connected to the first transparent substrate 31 (connecting portion P21). The tunable filter 30 also has the same functions and abilities as embodiments described above and the tunable filter 20, and is suitable for the optical communication apparatus 1.

The optical communication apparatus 1 of one or more embodiments is provided with a tunable filter 40 illustrated in FIG. 6 instead of the tunable filter 10 of embodiments described above. It should be understood that parts in the tunable filter 40 illustrated in FIG. 6 that have the same reference numerals as embodiments described above have the same configuration as the corresponding parts in embodiments described above. The optical communication apparatus 1 of one or more embodiments is configured the same as the optical communication apparatus 1 of embodiments described above except that the tunable filter 40 is partially different from embodiments described above.

As can be understood from FIG. 6, the tunable filter 40 has a vertically symmetrical structure. Specifically, the tunable filter 40 of one or more embodiments is provided with a first transparent substrate 41, the second transparent substrate 13, a base plate 43, a side wall plate 45, and the upper wall plate 25.

The first transparent substrate 41 is a transparent substrate having the same configuration as the first transparent substrate 11, and the same size as the second transparent substrate 13. The first transparent substrate 41 has a reflective surface 41R having a highly reflective coating 41A applied thereon, and an input surface 41N having a non-reflective coating 41B applied thereon. The reflective surface 41R is disposed to oppose the second reflective surface 13R separated from it a distance corresponding to the cavity length d, and functions as a first reflective surface 41R.

The base plate 43 is configured the same as the upper wall plate 25, and has an opening portion 43C for letting optical signals L1 be incident on the first transparent substrate 41. The side wall plate 45 is configured the same as the side wall plate 21 of embodiments described above except for that the thickness is different. The side wall plate 45 is configured to be thicker than the side wall plate 21 a distance corresponding to the thickness of the first transparent substrate 41. Due to this thickness, the side wall plate 45 forms a space that can house the first transparent substrate 41 and the second transparent substrate 13.

The first transparent substrate 41 is connected to the base plate 43 via an adhesive on the input surface 41N (connecting portion P31), and the second transparent substrate 13 is connected to the upper wall plate 25 via an adhesive on the output surface 13N (connecting portion P32). The base plate 43, side wall plate 45, and upper wall plate 25 are all connected together via an adhesive. For connecting, an adhesive having a filler mixed therein can be used similar to the embodiments above.

According to this example, the combination of the base plate 43, side wall plate 45, and upper wall plate 25 correspond to the supporting member, and the thermal expansions of plates 43, 45, and 25 positioned between the input surface 41N of the first transparent substrate 41 and the output surface 13N of the second transparent substrate 13 contribute to changing the cavity length d. Therefore, the cavity length d can be drastically changed at a small amount of change in temperature, and the variable range of transmitted wavelengths with respect to temperature change can be increased.

However, when changes in transmitted wavelengths are large with respect to temperature change, this may cause the control precision of transmitted wavelengths to decrease. Therefore, it is possible to selectively adopt the structure of the tunable filter 20 of embodiments described above or adopt the structure of the tunable filter 40 of one or more embodiments, based on the demanded wavelength variable range. The supporting member or plate material may be selected based on the demanded wavelength variable range.

Various embodiments are described above, but the present disclosure is not limited to the embodiments above, and various modes can be adopted. The art in the present disclosure has a larger change in cavity length d due to thermal expansion by making the length L between connecting points of first and second transparent substrates and a supporting member larger, compared to the conventional art which interposes a spacer between a first transparent substrate and a second transparent substrate and forms a cavity of a length corresponding to the thickness of the spacer. Therefore, the supporting member connected to the first and second transparent substrates can take various forms that can achieve similar effects.

Additionally, the functions of one component in the embodiments above may be provided separately in a plurality of components. The functions of a plurality of components can also be integrated in one component. A portion of the configurations of the embodiments above may be omitted. At least one portion of the configurations of the embodiments above may be added to or replace other configurations in the embodiments above. All modes that are included in the technical ideas identified from the wording in the scope of the claims are embodiments of the present invention.

### DESCRIPTION OF THE REFERENCE NUMERALS

1 . . . Optical communication apparatus,
10, 20, 30, 40 . . . Tunable filter,
11, 13, 31, 41 . . . Transparent substrate,
11R, 13R, 41R . . . Reflective surface,
15 . . . Supporting member,
15A . . . Side wall,
15B . . . Upper wall,
21, 45 . . . Side wall plate,
25 . . . Upper wall plate,
43 . . . Base plate,
70 . . . Temperature regulator,
80 . . . Temperature sensor,
90 . . . Controller,
L1 . . . Optical signal,
L2 . . . Optical signal,
P1, P2, P11, P12, P13, P21, P31, P32 . . . Connecting portion.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A tunable filter, comprising:
a first transparent substrate including a first reflective surface;
a second transparent substrate including a second reflective surface that opposes the first reflective surface; and
a supporting member, connected to the first transparent substrate, that supports the second transparent substrate on the first transparent substrate so that the second reflective surface is disposed at a position separated from the first reflective surface in a normal direction of the first reflective surface, wherein
a cavity between the first reflective surface and the second reflective surface forms an etalon,
a relative position of the second transparent substrate with respect to the first transparent substrate changes due to thermal expansion of the supporting member, and a length of the cavity changes in the normal direction,
the supporting member extends from a connection with the first transparent substrate toward the second transparent substrate, to a position separated farther from the first transparent substrate than the second reflective surface, and
the second transparent substrate is connected to the supporting member at a position separated from the first transparent substrate by the second reflective surface.

2. The tunable filter according to claim 1, wherein
the supporting member comprises:
a base plate that extends along a back surface of the first transparent substrate, wherein the back surface of the first transparent substrate is a side opposite to the first reflective surface;
a side wall that extends from a position corresponding to the back surface of the first transparent substrate toward the second transparent substrate to a position corresponding to a back surface of the second transparent substrate, wherein the back surface of the second transparent substrate is a side opposite the second reflective surface; and
an upper wall that extends along the back surface of the second transparent substrate, wherein
the back surface of the first transparent substrate is connected to the base plate of the supporting member at a position separated from the second transparent substrate by the first reflective surface, and
the back surface of the second transparent substrate is connected to the upper wall of the supporting member.

3. The tunable filter according to claim 2, wherein
the side wall is a first plate that surrounds the second transparent substrate, and
the upper wall is a second plate disposed on the first plate.

4. The tunable filter according to claim 3, wherein
the first plate is connected to the second plate with an adhesive including a filler that reduces thermal expansion.

5. The tunable filter according to claim 1, wherein
the supporting member is connected to the first transparent substrate and the second transparent substrate with an adhesive including a filler that reduces thermal expansion.

6. An optical communication apparatus comprising:
the tunable filter comprising:
a first transparent substrate including a first reflective surface;
a second transparent substrate including a second reflective surface that opposes the first reflective surface; and
a supporting member, connected to the first transparent substrate, that supports the second transparent substrate on the first transparent substrate so that the second reflective surface is disposed at a position separated from the first reflective surface in a normal direction of the first reflective surface; and
a temperature regulator that regulates a temperature of the tunable filter, wherein
a cavity between the first reflective surface and the second reflective surface forms an etalon,
a relative position of the second transparent substrate with respect to the first transparent substrate changes due to thermal expansion of the supporting member, and a length of the cavity changes in the normal direction,
the supporting member extends from a connection with the first transparent substrate toward the second transparent substrate, to a position separated farther from the first transparent substrate than the second reflective surface, and
the second transparent substrate is connected to the supporting member at a position separated from the first transparent substrate by the second reflective surface.

7. The tunable filter according to claim 2, wherein
the side wall and the upper wall are integral parts of the single supporting member, and
the upper wall extends from a side of the side wall that is perpendicular to the normal direction of the first reflective substrate.
